(19) United States
(12) Patent Application Publication
(10) Pub. No.: US 2024/0183042 A1
(43) Pub. Date: Jun. 6, 2024

(54) LUNAR BASE ENERGY SUPPLY AND APPLICATION SYSTEM BASED ON PHOTOCATALYTIC WATER SPLITTING HYDROGEN PRODUCTION TECHNOLOGY

(71) Applicant: XI'AN AEROSPACE PROPULSION INSTITUTE, Xi'an, Shaanxi (CN)

(72) Inventors: Yonghua TAN, Xi'an, Shaanxi (CN); Guangxu WANG, Xi'an, Shaanxi (CN); Feiping DU, Xi'an, Shaanxi (CN); Jun WANG, Xi'an, Shaanxi (CN); Xing LI, Xi'an, Shaanxi (CN); Baoe YANG, Xi'an, Shaanxi (CN); Dongqin SHANG, Xi'an, Shaanxi (CN); Yu YAN, Xi'an, Shaanxi (CN)

(21) Appl. No.: 18/553,405

(22) PCT Filed: Sep. 23, 2021
(86) PCT No.: PCT/CN2021/119740

§ 371 Date: Sep. 29, 2023

(30) Foreign Application Priority Data
Apr. 14, 2021 (CN) 202110401123.6

(51) Int. Cl. C25B 1/04; B64G 99/00; C25B 1/55; C25B 15/08; H01M 8/0656; H02J 3/38; H02S 10/10

(52) U.S. Cl. CPC C25B 1/04; B64G 99/00; C25B 1/55; C25B 15/083; H01M 8/0656; H02J 3/38; H02S 10/10

(57) ABSTRACT

A lunar base energy supply and application system based on photocatalytic water splitting hydrogen production technology are provided. The system includes a solar photovoltaic power generation unit, a power management unit, a water storage tank, a photocatalytic water splitting unit, an hydrogen-oxygen storage unit, an hydrogen-oxygen-water conversion unit, a condition monitoring unit, a chemical propulsion unit, an environmental control and life support unit, and a load. The photocatalytic water splitting unit and the hydrogen-oxygen-water conversion unit can generate hydrogen and oxygen, and the solar photovoltaic power generation unit and the hydrogen-oxygen-water conversion unit can generate electric power, thus ensuring stable supply of energy at the lunar base.

### TECHNICAL FIELD

The present disclosure relates to the technical field of lunar base energy supply, and in particular to a lunar base energy supply and application system based on photocatalytic water splitting hydrogen production technology.

### BACKGROUND

Generally, we call all the infrastructures established on the moon that can be used for human beings to live and carry out various technical experiments, scientific research and resource development for a long time as the lunar base. The lunar base must be supported by energy and power on the lunar surface, so as to provide basic guarantee for the lunar base itself, astronauts, lunar rovers, various scientific instruments and operation tools, communication and navigation facilities, etc.

In the space station project, the energy and power needed by spacecraft are provided by using large solar array technology. In the short-term manned mission to the moon, the lunar spacecraft uses hydrogen-oxygen fuel cells for power supply. For the long-term lunar base mission, due to the participation of astronauts, it is necessary to provide life support and health support systems, which makes the equipment and instruments of the lunar base increase, and the energy demand increases significantly. A single energy supply mode cannot meet the energy demand of the lunar base, and cannot guarantee the stable supply of energy in the base. Therefore, the energy problem has become a prominent problem, which needs to rely on a variety of energy supply modes to meet the demand.

### SUMMARY

The purpose of the disclosure is to solve the problem that the energy demand in the long-term lunar base mission is significantly increased, the single energy supply mode can not meet the energy demand of the lunar base and can not guarantee the stable energy supply of the base, and to provide a lunar base energy supply and application system based on photocatalytic water splitting hydrogen production technology.

Foreign surveys have found that there is water ice in the permanent shadow area of the Antarctic region of the moon, which is estimated to be at least 600 million tons. Water ice can be purified into drinking water and decomposed to obtain hydrogen and oxygen, among which hydrogen and oxygen can be used for power generation and as engine propellant, and oxygen can also be used for astronauts to breathe. Therefore, these water ice resources can be utilized by in-situ preparation, and the efficient conversion of space water-hydrogen/oxygen-electricity can be realized by photocatalytic water splitting and hydrogen-oxygen-water conversion technology, so as to solve the energy supply problem of lunar base when there is no light on moonlit nights.

To achieve the above purpose, the technical solutions adopted by the present disclosure are as follows:
a lunar base energy supply and application system based on photocatalytic water splitting hydrogen production technology, which is special in that:
the system includes a solar photovoltaic power generation unit, a power management unit, a water storage tank, a photocatalytic water splitting unit, a hydrogen-oxygen storage unit, a hydrogen-oxygen-water conversion unit, a state monitoring unit, a chemical propulsion unit, an environmental control and life support unit and a load; wherein
an electric power output end of the solar photovoltaic power generation unit is connected with an electric power input end of the power management unit;
the photocatalytic water splitting unit includes an electrolytic tank, a proton exchange membrane, a hydrogen generation electrode, an oxygen generation electrode and a concentrator; the proton exchange membrane is disposed inside the electrolytic tank and divides the electrolytic tank into a hydrogen generation chamber and an oxygen generation chamber left and right; a water inlet of the oxygen generation chamber is connected with a water outlet of the water storage tank; the hydrogen generation electrode and the oxygen generation electrode are respectively disposed inside the hydrogen generation chamber and the oxygen generation chamber; the concentrator is disposed above the oxygen generation chamber for collecting sunlight;
the hydrogen-oxygen storage unit includes a hydrogen vapor separator, a hydrogen storage tank, an oxygen vapor separator and an oxygen storage tank; a gas outlet of the hydrogen generation chamber of the photocatalytic water splitting unit is connected with a gas inlet of the hydrogen vapor separator, a gas outlet of the hydrogen vapor separator is connected with a gas inlet of the hydrogen storage tank, a water outlet of the hydrogen vapor separator is connected with a water inlet of the water storage tank; a gas outlet of the oxygen generation chamber of the photocatalytic water splitting unit is connected with a gas inlet of the oxygen vapor separator, a gas outlet of the oxygen vapor separator is connected with a gas inlet of the oxygen storage tank, and a water outlet of the oxygen vapor separator is connected with a water inlet of the water storage tank;
the hydrogen-oxygen-water conversion unit is a hydrogen-oxygen fuel cell and a water electrolysis device which are split, or an integrated renewable fuel cell;
a hydrogen inlet of the hydrogen-oxygen fuel cell is connected with a gas outlet of the hydrogen storage tank, an oxygen inlet thereof is connected with the gas outlet of the oxygen storage tank, a water outlet thereof is connected with the water inlet of the water storage tank, and an electric power output end thereof is connected with the electric power input end of the power management unit; an electric power input end of the water electrolysis device is connected with an electric power output end of the power management unit, a water inlet thereof is connected with the water outlet of the water storage tank, a hydrogen outlet thereof is connected with the gas inlet of the hydrogen storage tank, and an oxygen outlet thereof is connected with the gas inlet of the oxygen storage tank; a hydrogen inlet/outlet of the integrated renewable fuel cell is connected with the hydrogen storage tank, an oxygen inlet/outlet thereof is connected with the oxygen storage tank, a water inlet/outlet thereof is connected with the water storage tank, and an electric power input and output end thereof is connected with the power management unit;
the chemical propulsion unit is powered by hydrogen and oxygen, an hydrogen inlet thereof is connected with the gas outlet of the hydrogen storage tank, an oxygen inlet thereof is connected with the gas outlet of the oxygen storage tank, and an electrical power input end thereof is connected with the electrical power output end of the power management unit;
the environmental control and life support unit is configured to control and secure the living environment of the lunar base, an oxygen inlet thereof is connected with the gas outlet of the oxygen storage tank, an electric power input end thereof is connected with the electric power output end of the power management unit, and an water outlet is connected with the water inlet of the water storage tank;
an electrical power input end of the load is connected with the electrical power output end of the power management unit;
the state monitoring unit is configured to monitor the operating states of the solar photovoltaic power generation unit, the water storage tank, the hydrogen-oxygen storage unit, the environmental control and life support unit, the chemical propulsion unit and the load, and feed back the electricity demand to the power management unit; and
the power management unit supplies power according to the electricity demand fed back by the state monitoring unit.

Further, the hydrogen-oxygen storage unit further includes a hydrogen booster pump and an oxygen booster pump; a gas inlet of the hydrogen booster pump is connected with the gas outlet of the hydrogen vapor separator, and a gas outlet thereof is connected with the gas inlet of the hydrogen storage tank; a gas inlet of the oxygen booster pump is connected with the gas outlet of the oxygen vapor separator and a gas outlet thereof is connected with the gas inlet of the oxygen storage tank. Further, the solar photovoltaic power generation unit includes a solar panel, a solar controller, a storage battery and an inverter; the solar panel converts solar energy directly into electric power, and stores a part of the electric power inside the storage battery through the solar controller; the inverter inverts the low voltage DC supplied from the solar panel and the storage battery into 220 V AC, and outputs electric power to the outside.

Further, the oxygen generation electrode is formed by a self-biased PN junction and a semiconductor photoanode coupled in series.

Further, the storage pressure of the hydrogen storage tank and the oxygen storage tank is rated between 2 MPa and 8 MPa.

The beneficial effects of the present disclosure are:

The present disclosure proposes a lunar base energy supply and application system based on photocatalytic water splitting hydrogen production technology, when illumination is sufficient, on one hand, the solar photovoltaic power generation unit is used for power generation and energy storage, on the other hand, the photocatalytic water splitting unit is used for hydrogen production and oxygen production, and the hydrogen and oxygen are stored to reserve energy and provide oxygen for the lunar base. When there is no light on the moonlit night, on one hand, the energy stored by the solar photovoltaic power generation unit can be used to continue energy supply, on the other hand, the stored hydrogen and oxygen can be supplied to the hydrogen-oxygen-water conversion unit for power generation and energy supply to ensure the stable energy supply of the lunar base. When the amount of hydrogen and oxygen needed is large, the photocatalytic water splitting unit and the hydrogen-oxygen-water conversion unit can be used to produce hydrogen and oxygen at the same time. When there is power demand, the generated hydrogen and oxygen can be supplied to the engine to generate thrust.

The solar photovoltaic power generation is the main energy supply mode of the lunar base, and the hydrogen-oxygen-water conversion power generation is the auxiliary emergency energy supply mode. Hydrogen production by photocatalytic water splitting is the best way for solar photochemical conversion and storage. The disclosure combines the photocatalytic water splitting unit and the hydrogen-oxygen-water conversion unit to realize the efficient conversion of space water-hydrogen/oxygen-electricity, and effectively solves the problem of stable energy supply of the lunar base when there is no illumination on a moonlit night.

### BRIEF DESCRIPTION OF FIGURES

FIG. 1 is a block diagram illustrating the structure of a lunar base energy supply and application system based on photocatalytic water splitting hydrogen production technology according to the present disclosure;

FIG. 2 is a block diagram illustrating the structure of a solar photovoltaic power generation unit according to the present disclosure;

FIG. 3 is a schematic diagram illustrating the structure of a water storage tank according to the present disclosure;

FIG. 4 is a schematic diagram illustrating the structure of a photocatalytic water splitting unit according to the present disclosure;

FIG. 5 is a schematic diagram illustrating the operation of a hydrogen-oxygen storage unit according to the present disclosure; and

FIG. 6 is a schematic diagram illustrating the operation of an integrated renewable fuel cell according to the present disclosure.

In the drawings, 1—water storage tank, 2—solar photovoltaic power generation unit, 3—power management unit, 4—photocatalytic water splitting unit, 5—hydrogen-oxygen-water conversion unit, 6—state monitoring unit, 7—hydrogen-oxygen storage unit, 8—chemical propulsion unit, 9—environmental control and life support unit, 10—load, 11—water inlet valve, 12—water outlet valve, 13—solar panel, 14—solar controller, 15—storage battery, 16—inverter, 17—concentrator, 18—hydrogen generation electrode, 19—oxygen generation electrode, 20—electrolytic tank, 21—proton exchange membrane, 22—hydrogen generation chamber, 23—oxygen generation chamber, 24—hydrogen vapor separator, 25—oxygen vapor separator, 26—hydrogen booster pump, 27—oxygen booster pump, 28—hydrogen storage tank, 29—oxygen storage tank.

### DETAILED DESCRIPTION

In order that the objectives, advantages and features of the present disclosure will become more apparent, the lunar base energy supply and application system based on photocatalytic water splitting hydrogen production technology according to the present disclosure will be described in further detail with reference to the accompanying drawings and specific embodiments thereof.

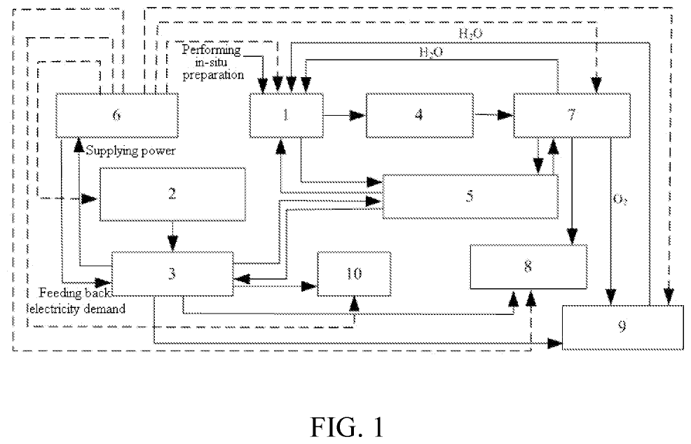

As shown in FIG. 1, the system includes a solar photovoltaic power generation unit 2, a power management unit 3, a water storage tank 1, a photocatalytic water splitting unit 4, a hydrogen-oxygen storage unit 7, a hydrogen-oxygen-water conversion unit 5, a state monitoring unit 6, a chemical propulsion unit 8, an environmental control and life support unit 9 and a load 10. The solar photovoltaic power generation unit 2 and the hydrogen-oxygen-water conversion unit 5 may produce electrical power, and the photocatalytic water splitting unit 4 and the hydrogen-oxygen-water conversion unit 5 may produce hydrogen and oxygen.

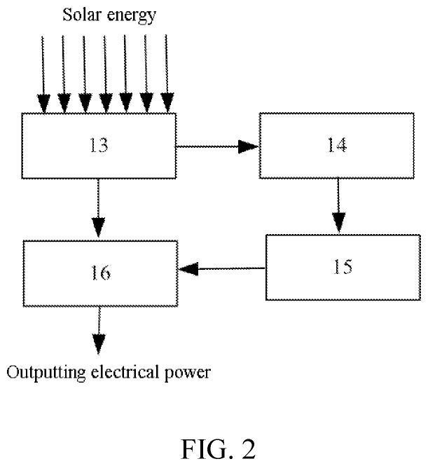

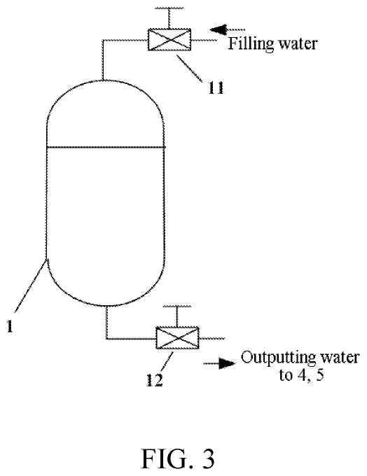

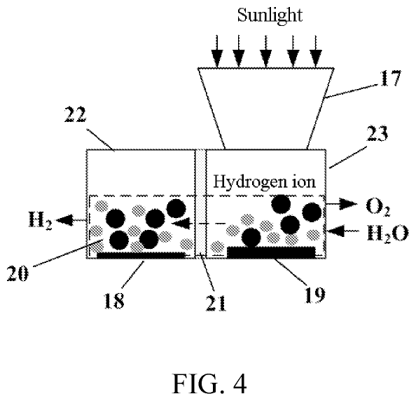

As shown in FIG. 2, the solar photovoltaic power generation unit 2 includes a solar panel 13, a solar controller 14, a storage battery 15 and an inverter 16. The solar panel 13 converts solar energy directly into electrical power for use by the load 10 or the like or the electrical power is stored in the storage battery 15 for use. The solar controller 14 stores a part of the electrical power generated by the solar panel 13 in the storage battery 15. The solar controller 14 can provide the storage battery 15 with an optimal charging current and voltage to charge the storage battery 15 quickly, smoothly, and efficiently. The inverter 16 inverts the low voltage DC supplied from the solar panel 13 and the storage battery 15 into 220 V AC, and outputs electric power to the outside. The electric power output end of the solar photovoltaic power generation unit 2 is connected with the electric power input end of the power management unit 3, and power is supplied to the hydrogen-oxygen-water conversion unit 5, the state monitoring unit 6, the chemical propulsion unit 8, the environmental control and life support unit 9, and the load 10 through the power management unit 3. As shown in FIG. 3, the water of the water storage tank 1 is mainly obtained by in-situ preparation technology for supplying water to the photocatalytic water splitting unit 4 and the hydrogen-oxygen-water conversion unit 5. The top of the water storage tank 1 is provided with a water inlet, a connecting pipeline of the water inlet is provided with a water inlet valve 11 for controlling filling of water; a water outlet is provided at the bottom of the water storage tank 1, and a water outlet valve 12 is provided on a connecting pipeline of the water outlet for controlling the output of water. As shown in FIG. 4, the photocatalytic water splitting unit 4 includes an electrolytic tank 20, a proton exchange membrane 21, a hydrogen generation electrode 18, an oxygen generation electrode 19 and a concentrator 17. The proton exchange membrane 21 is disposed inside the electrolytic tank 20 and divides the electrolytic tank 20 into a hydrogen generation chamber 22 and an oxygen generation chamber 23 left and right. A water inlet of the oxygen generation chamber 23 is connected with a water outlet of the water storage tank 1. The hydrogen generation electrode 18 and the oxygen generation electrode 19 are respectively disposed inside the hydrogen generation chamber 22 and the oxygen generation chamber 23, and immersed in the electrolytic solution. The oxygen generation electrode 19 is formed by a self-biased PN junction and a semiconductor photoanode coupled in series to enable hydrogen and oxygen production without external power input. The concentrator 17 is disposed above the oxygen generation chamber 23 for collecting sunlight. Under light irradiation and a certain self-bias voltage, water starts to photolyze, hydrogen ions enter the hydrogen generation chamber 22 through the proton exchange membrane 21, the hydrogen generation electrode 18 and the oxygen generation electrode 19 generate hydrogen and oxygen, respectively, and hydrogen and oxygen generated by the photocatalytic water splitting unit 4 are stored in the hydrogen-oxygen storage unit 7.

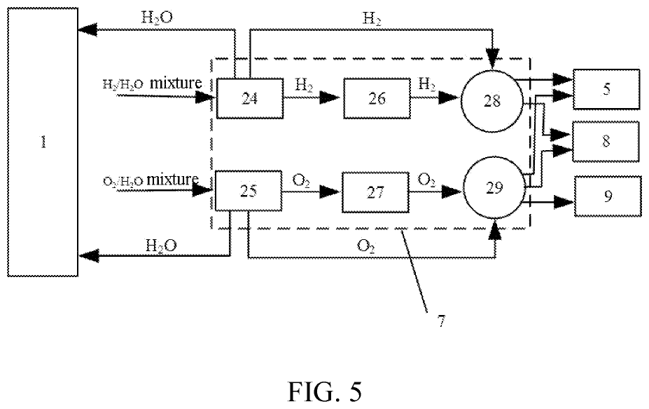

As shown in FIG. 5, the hydrogen-oxygen storage unit 7 includes a hydrogen vapor separator 24, a hydrogen booster pump 26, a hydrogen storage tank 28, an oxygen vapor separator 25, an oxygen booster pump 27, and an oxygen storage tank 29. The rated storage pressure of the hydrogen storage tank 28 and the oxygen storage tank 29 is 2 MPa-8 MPa. A gas outlet of the hydrogen generation chamber 22 of the photocatalytic water splitting unit 4 is connected with a gas inlet of the hydrogen vapor separator 24, a gas outlet of the hydrogen vapor separator 24 is connected with a gas inlet of the hydrogen storage tank 28, a water outlet of the hydrogen vapor separator 24 is connected with a water inlet of the water storage tank 1; a gas outlet of the oxygen generation chamber 23 of the photocatalytic water splitting unit 4 is connected with a gas inlet of the oxygen vapor separator 25, a gas outlet of the oxygen vapor separator 25 is connected with a gas inlet of the oxygen storage tank 29, and a water outlet of the oxygen vapor separator 25 is connected with a water inlet of the water storage tank 1; a gas inlet of the hydrogen booster pump 26 is connected with the gas outlet of the hydrogen vapor separator 24, and a gas outlet thereof is connected with the gas inlet of the hydrogen storage tank 28; a gas inlet of the oxygen booster pump 27 is connected with the gas outlet of the oxygen vapor separator 25 and a gas outlet thereof is connected with the gas inlet of the oxygen storage tank 29.

The hydrogen-oxygen-water conversion unit 5 is a hydrogen-oxygen fuel cell and a water electrolysis device which are split, or an integrated renewable fuel cell.

In the form that the hydrogen-oxygen fuel cell and the water electrolysis device are split, a hydrogen inlet of the hydrogen-oxygen fuel cell is connected with a gas outlet of the hydrogen storage tank 28, an oxygen inlet thereof is connected with the gas outlet of the oxygen storage tank 29, a water outlet thereof is connected with the water inlet of the water storage tank 1, and an electric power output end thereof is connected with the electric power input end of the power management unit 3. An electric power input end of the water electrolysis device is connected with an electric power output end of the power management unit 3, a water inlet thereof is connected with the water outlet of the water storage tank 1, a hydrogen outlet thereof is connected with the gas inlet of the hydrogen storage tank 28, and an oxygen outlet thereof is connected with the gas inlet of the oxygen storage tank 29.

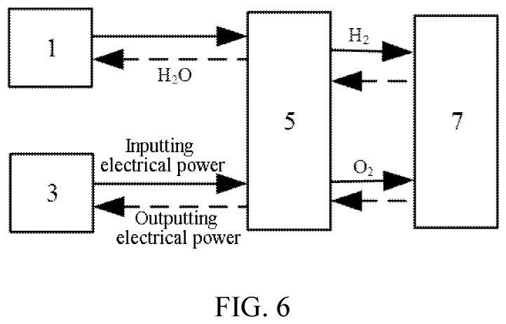

As shown in FIG. 6, this embodiment takes the form of an integrated renewable fuel cell, the water electrolysis function and the fuel cell function of the integrated renewable fuel cell are completed by the same assembly, a hydrogen inlet/outlet of the integrated renewable fuel cell is connected with the hydrogen storage tank 28, an oxygen inlet/outlet thereof is connected with the oxygen storage tank 29, a water inlet/outlet thereof is connected with the water storage tank 1, and an electric power input and output end thereof is connected with the power management unit 3.

When the hydrogen-oxygen demand is large, the water in the water storage tank 1 is inputted into the hydrogen-oxygen-water conversion unit 5, the water is electrolyzed into hydrogen and oxygen under the action of electric power and stored into the hydrogen-oxygen storage unit 7; when the electricity usage demand is large, the hydrogen and oxygen in the hydrogen-oxygen storage unit 7 is passed into the hydrogen-oxygen-water conversion unit 5, electric power is generated by the function of the fuel cell, and power is supplied externally through the power management unit 3.

The hydrogen and oxygen photolyzed by the photocatalytic water splitting unit 4 or electrolyzed by the hydrogen-oxygen-water conversion unit 5 are subjected to water-gas separation by the hydrogen vapor separator 24 and the oxygen vapor separator 25, respectively, and the separated water is returned to the water storage tank 1, and the separated hydrogen and oxygen are stored in the hydrogen storage tank 28 and the oxygen storage tank 29, respectively. When the pressure of the hydrogen photolyzed by the photocatalytic water splitting unit 4 or electrolyzed by the hydrogen-oxygen-water conversion unit 5 is higher than the pressure in the hydrogen storage tank 28, the generated hydrogen is directly stored in the hydrogen storage tank 28; when the pressure of the hydrogen photolyzed by the photocatalytic water splitting unit 4 or electrolyzed by the hydrogen-oxygen-water conversion unit 5 is lower than the pressure in the hydrogen storage tank 28, the generated hydrogen is pressurized by the hydrogen booster pump 26 and stored in the hydrogen storage tank 28. Similarly, when the pressure of the oxygen photolyzed by the photocatalytic water splitting unit 4 or electrolyzed by the hydrogen-oxygen-water conversion unit 5 is higher than the pressure in the oxygen storage tank 29, the generated oxygen is directly stored in the oxygen storage tank 29; when the pressure of the oxygen photolyzed by the photocatalytic water splitting unit 4 or electrolyzed by the hydrogen-oxygen-water conversion unit 5 is lower than the pressure in the oxygen storage tank 29, the generated oxygen is pressurized by the oxygen booster pump 27 and stored in the oxygen storage tank 29.

The chemical propulsion unit 8 is fueled by hydrogen and oxygen to power a lunar surface vehicle or to power a lunar surface emission detector, an hydrogen inlet thereof is connected with the gas outlet of the hydrogen storage tank 28, an oxygen inlet thereof is connected with the gas outlet of the oxygen storage tank 29, and an electrical power input end thereof is connected with the electrical power output end of the power management unit 3.

The environmental control and life support unit 9 is a perfected environmental control and life support system capable of creating a suitable living environment for astronauts and provide necessary material conditions, an oxygen inlet of the environmental control and life support unit 9 is connected with the gas outlet of the oxygen storage tank 29, an electric power input end thereof is connected with the electric power output end of the power management unit 3, and an water outlet is connected with the water inlet of the water storage tank 1

The load 10 refers to a variety of instrumentation equipment at the lunar base that requires energy to be supplied, an electrical power input end thereof is connected with the electrical power output end of the power management unit 3.

The state monitoring unit 6 is configured to monitor the operating states of the solar photovoltaic power generation unit 2, the water storage tank 1, the hydrogen-oxygen storage unit 7, the environmental control and life support unit 9, the chemical propulsion unit 8 and the load 10, and feed back the electricity demand to the power management unit 3.

The power management unit 3 decides which mode to supply power according to the electricity demand fed back by the state monitoring unit 6. Solar photovoltaic power generation is the main energy supply mode for the lunar base, and hydrogen-oxygen-water conversion power generation is the auxiliary emergency energy supply mode.

1. A lunar base energy supply and application system based on photocatalytic water splitting hydrogen production technology, comprising:
a solar photovoltaic power generation unit (2), a power management unit (3), a water storage tank (1), a photocatalytic water splitting unit (4), a hydrogen-oxygen storage unit (7), a hydrogen-oxygen-water conversion unit (5), a state monitoring unit (6), a chemical propulsion unit (8), an environmental control and life support unit (9) and a load (10); wherein
an electric power output end of the solar photovoltaic power generation unit (2) is connected with an electric power input end of the power management unit (3);
the photocatalytic water splitting unit (4) comprises an electrolytic tank (20), a proton exchange membrane (21), a hydrogen generation electrode (18), an oxygen generation electrode (19) and a concentrator (17); the proton exchange membrane (21) is disposed inside the electrolytic tank (20) and divides the electrolytic tank (20) into a hydrogen generation chamber (22) and an oxygen generation chamber (23) left and right; a water inlet of the oxygen generation chamber (23) is connected with a water outlet of the water storage tank (1); the hydrogen generation electrode (18) and the oxygen generation electrode (19) are respectively disposed inside the hydrogen generation chamber (22) and the oxygen generation chamber (23); the concentrator (17) is disposed above the oxygen generation chamber (23) for collecting sunlight;
the hydrogen-oxygen storage unit (7) comprises a hydrogen vapor separator (24), a hydrogen storage tank (28), an oxygen vapor separator (25) and an oxygen storage tank (29); a gas outlet of the hydrogen generation chamber (22) of the photocatalytic water splitting unit (4) is connected with a gas inlet of the hydrogen vapor separator (24), a gas outlet of the hydrogen vapor separator (24) is connected with a gas inlet of the hydrogen storage tank (28), a water outlet of the hydrogen vapor separator (24) is connected with a water inlet of the water storage tank (1); a gas outlet of the oxygen generation chamber (23) of the photocatalytic water splitting unit (4) is connected with a gas inlet of the oxygen vapor separator (25), a gas outlet of the oxygen vapor separator (25) is connected with a gas inlet of the oxygen storage tank (29), and a water outlet of the oxygen vapor separator (25) is connected with a water inlet of the water storage tank (1);
the hydrogen-oxygen-water conversion unit (5) is a hydrogen-oxygen fuel cell and a water electrolysis device which are split, or an integrated renewable fuel cell;
a hydrogen inlet of the hydrogen-oxygen fuel cell is connected with a gas outlet of the hydrogen storage tank (28), an oxygen inlet thereof is connected with the gas outlet of the oxygen storage tank (29), a water outlet thereof is connected with the water inlet of the water storage tank (1), and an electric power output end thereof is connected with the electric power input end of the power management unit (3); an electric power input end of the water electrolysis device is connected with an electric power output end of the power management unit (3), a water inlet thereof is connected with the water outlet of the water storage tank (1), a hydrogen outlet thereof is connected with the gas inlet of the hydrogen storage tank (28), and an oxygen outlet thereof is connected with the gas inlet of the oxygen storage tank (29);
a hydrogen inlet/outlet of the integrated renewable fuel cell is connected with the hydrogen storage tank (28), an oxygen inlet/outlet thereof is connected with the oxygen storage tank (29), a water inlet/outlet thereof is connected with the water storage tank (1), and an electric power input and output end thereof is connected with the power management unit (3);
the chemical propulsion unit (8) is powered by hydrogen and oxygen, an hydrogen inlet thereof is connected with the gas outlet of the hydrogen storage tank (28), an oxygen inlet thereof is connected with the gas outlet of the oxygen storage tank (29), and an electrical power input end thereof is connected with the electrical power output end of the power management unit (3);
the environmental control and life support unit (9) is configured to control and secure the living environment of the lunar base, an oxygen inlet thereof is connected with the gas outlet of the oxygen storage tank (29), an electric power input end thereof is connected with the electric power output end of the power management unit (3), and an water outlet is connected with the water inlet of the water storage tank (1);
an electrical power input end of the load (10) is connected with the electrical power output end of the power management unit (3);
the state monitoring unit (6) is configured to monitor the operating states of the solar photovoltaic power generation unit (2), the water storage tank (1), the hydrogen-oxygen storage unit (7), the environmental control and life support unit (9), the chemical propulsion unit (8) and the load (10), and feed back the electricity demand to the power management unit (3); and
the power management unit (3) supplies power according to the electricity demand fed back by the state monitoring unit (6).

2. The lunar base energy supply and application system based on photocatalytic water splitting hydrogen production technology according to claim 1, wherein,
the hydrogen-oxygen storage unit (7) further comprises a hydrogen booster pump (26) and an oxygen booster pump (27); a gas inlet of the hydrogen booster pump (26) is connected with the gas outlet of the hydrogen vapor separator (24), and a gas outlet thereof is connected with the gas inlet of the hydrogen storage tank (28); a gas inlet of the oxygen booster pump (27) is connected with the gas outlet of the oxygen vapor separator (25) and a gas outlet thereof is connected with the gas inlet of the oxygen storage tank (29).

3. The lunar base energy supply and application system based on photocatalytic water splitting hydrogen production technology according to claim 1, wherein,
the solar photovoltaic power generation unit (2) comprises a solar panel (13), a solar controller (14), a storage battery (15) and an inverter (16); the solar panel (13) converts solar energy directly into electric power, and stores a part of the electric power inside the storage battery (15) through the solar controller (14); the inverter (16) inverts the low voltage DC supplied from the solar panel (13) and the storage battery (15) into 220 V AC, and outputs electric power to the outside.

4. The lunar base energy supply and application system based on photocatalytic water splitting hydrogen production technology according to claim 3, wherein,
the oxygen generation electrode (19) is formed by a self-biased PN junction and a semiconductor photoanode coupled in series.

5. The lunar base energy supply and application system based on photocatalytic water splitting hydrogen production technology according to claim 4, wherein,
the storage pressure of the hydrogen storage tank (28) and the oxygen storage tank (29) is rated between 2 MPa and 8 MPa.
